(19) United States
(12) Patent Application Publication
(10) Pub. No.: US 2009/0317183 A1
(43) Pub. Date: Dec. 24, 2009

(54) ASSEMBLY AID FOR A STEERING COLUMN

(75) Inventors: Charles Fritz, New Hartford, CT (US); Kevin Audibert, Wolcott, CT (US); Jeffrey Varesio, Prospect, CT (US); John Sarlo, Middlebury, CT (US)

Correspondence Address: ARTHUR G. SCHAIER;CARMODY & TORRANCE LLP, 50 LEAVENWORTH STREET, P.O. BOX 1110, WATERBURY, CT, 06721, US

(73) Assignee: DriveSol Worldwide, Inc., Troy, MI (US)

(21) Appl. No.: 12/162,693

(22) PCT Filed: Feb. 2, 2007
(86) PCT No.: PCT/US07/61534

§ 371 Date: Jun. 23, 2009

Related U.S. Application Data
(60) Provisional application No. 60/765,470, filed on Feb. 3, 2006.

(51) Int. Cl. F16B 7/00

(52) U.S. Cl. 403/409.1

(57) ABSTRACT

A shaft assembly (15) includes an outer member (48) having an aperture (44), a shaft (20) having an end (40) configured to be received in the aperture of the outer member, and an insertion aid (70) coupled with the end of the shaft to facilitate insertion of the shaft into the aperture in the outer member. The insertion aid can take the form of a plug coupled to the end of the shaft.

### RELATED APPLICATIONS

This application claims the benefit of U.S. Provisional Patent Application No. 60/765,470 filed Feb. 3, 2006, the entire content of which is hereby incorporated by reference.

### BACKGROUND

The present invention relates to steering column assemblies, and more particularly to motor vehicle steering column assemblies having an intermediate shaft assembly.

Intermediate shaft assemblies often include a hollow shaft having an end received in the bore of a yoke or hollow tube. The bore of the yoke typically corresponds generally in shape to the outside surface of the end of the hollow shaft.

### SUMMARY

Assembly of the hollow shaft into the bore of the yoke typically occurs at the automobile assembly plant. Due to the location of the intermediate shaft assembly within the vehicle, the assembler often has only a limited view or sometimes no view of the parts being assembled. When the shape and size of the outside surface of the end of the hollow shaft closely matches the shape and size of the bore in the yoke, assembly of the shaft into the yoke can be difficult and time consuming. Careful alignment and manipulation, often with limited or no view of the parts, is required in order to insert the end of the shaft into the bore. This difficulty with assembly can slow the assembly process.

It is possible to chamfer the end of the hollow shaft to provide for easier insertion into the bore of the yoke. However, this chamfer must be machined onto the end of the hollow shaft, requiring additional machining time. More importantly, the ends of many hollow shafts used for intermediate shaft assemblies have D shaped or double-D shaped outer surfaces. In other words, one or two sides of what would otherwise be a square or rectangular outer shaft profile are curved. Machining a chamfer on such shafts is difficult and expensive, requiring multiple operations to provide a continuous chamfer on both the straight wall portions and the curved wall portions of the end of the shaft.

The invention provides an assembly aid that facilitates assembling the intermediate shaft assembly. More specifically, the invention provides a shaft assembly including an outer member having an aperture, a shaft having an end configured to be received in the aperture of the outer member, and an insertion aid coupled with the end of the shaft to facilitate insertion of the shaft into the aperture in the outer member.

In one embodiment, the insertion aid takes the form of a plug that is coupled to the end of the shaft. The plug is formed with a chamfered or tapered end that facilitates insertion of the plug, and therefore the connected shaft, into the outer member.

The invention further provides a shaft assembly having an outer member with an aperture, a hollow shaft having an end configured to be received in the aperture of the outer member, and a plug having a body portion configured to be received in the end of the hollow shaft. The body portion includes a transverse recess configured to aid in the formation of a transverse recess in the hollow shaft.

The invention also provides a shaft assembly having an outer member with an aperture, a hollow shaft having an end configured to be received in the aperture of the outer member, and a plug having a body portion configured to be received in the end of the hollow shaft. The body portion includes a forming feature configured to deform a tube received within the hollow shaft and over the body portion of the plug. In one embodiment, the forming feature is a rib.

Other aspects of the invention will become apparent by consideration of the detailed description and accompanying drawings.

### BRIEF DESCRIPTION OF THE DRAWINGS

FIG. 1 is a fragmentary view of a vehicle having a steering column and linkage assembly embodying the present invention.

FIG. 2 is a perspective view of an assembled intermediate shaft assembly.

FIG. 3 is a perspective view similar to FIG. 2 illustrating one end of the intermediate shaft assembly disconnected from a yoke.

FIG. 4 is an enlarged perspective view showing the end of the intermediate shaft assembly disconnected from the yoke, and illustrating an insertion aid inserted into the end of the intermediate shaft assembly.

FIG. 5 is an enlarged side view illustrating the insertion aid inserted into the end of the intermediate shaft assembly.

FIG. 5a is a view similar to FIG. 5 illustrating the operation of a forming feature of the insertion aid.

FIG. 6 is a perspective view of the insertion aid.

FIG. 7 is a side view of the insertion aid of FIG. 6.

FIG. 8 is a top view of the insertion aid of FIG. 6.

FIG. 9 is an end view of the insertion aid of FIG. 6.

FIGS. 10-13 illustrate a second embodiment of an insertion aid.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

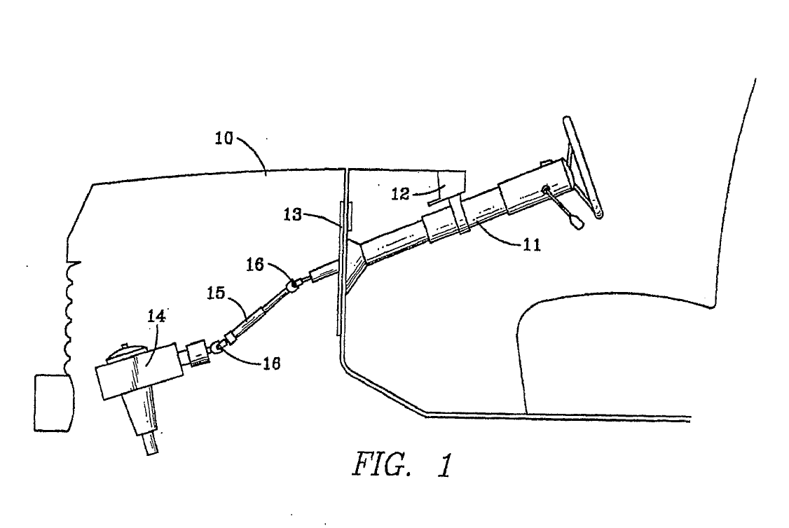

As shown in FIG. 1, a vehicle 10 typically has a steering column 11 mounted upon a bracket 12 which is either part of the dashboard (as shown) or part of the fire wall 13. The lower portion of the steering column 11 is connected to a steering gear mechanism 14 by way of a separable intermediate shaft assembly 15 having universal joint connections 16 at both ends. The specific connections of the universal joints 16 to yokes and other linkages can vary from that shown in FIG. 1. Additionally, the gear mechanism 14 can alternatively be a rack and pinion mechanism or other steering mechanism. The intermediate shaft assembly 15 typically includes a number of components that are commonly assembled at the vehicle assembly plant. Due to the location of the intermediate shaft assembly 15 within the vehicle 10, the assembler often has only a limited view or sometimes no view of the parts being assembled. The present invention facilitates assembly of the intermediate shaft assembly 15.

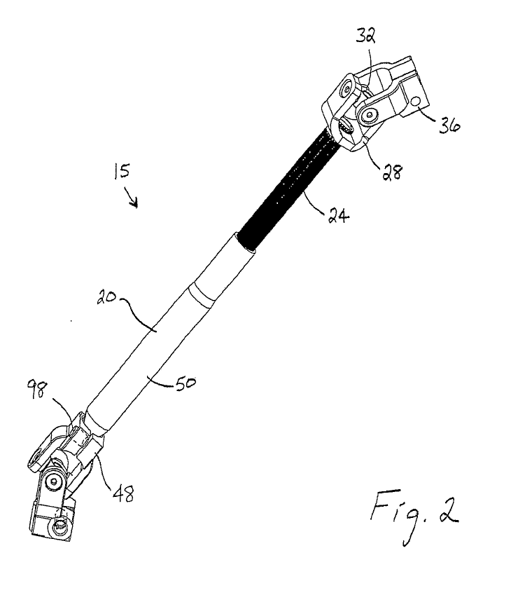

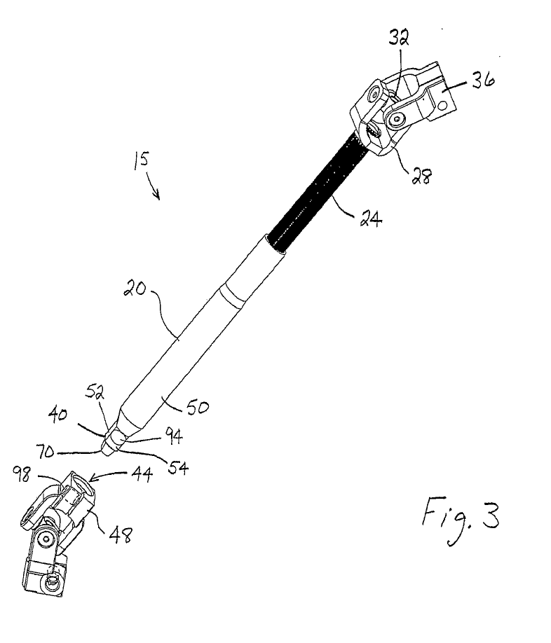

The intermediate shaft assembly 15 is shown in more detail in FIGS. 2-4, and includes a hollow outer tube or shaft 20 that receives an end of a splined inner tube or shaft 24. As shown in FIGS. 2 and 3, the end of the inner tube 24 not received in the hollow shaft 20 is coupled to a yoke 28 for connection to a universal joint 32 and to another yoke 36. The outer shaft 20 has an end 40 (see FIGS. 3 and 4) configured to be received in an aperture 44 of an outer member, which in the illustrated embodiment, takes the form of a clamp yoke 48. In other embodiments, the outer member could take various other forms, including different types of yokes or a hollow tube. FIG. 2 illustrates the end 40 of the shaft 20 inserted into the aperture 44 of the yoke 48.

Referring to FIGS. 3-5, the end 40 of the shaft 20 is tapered from a larger circular diameter of a body portion 50 of the shaft 20. In the illustrated embodiment, the end 40 of the shaft 20 tapers down to a generally double-D shape configuration. In other words, the end 40 of the shaft 20 remains a hollow tube with two oppositely facing, generally straight sidewalls 52 (only one is shown in FIG. 3), and two oppositely facing, generally curved sidewalls 54.

Referring now to FIG. 4, the aperture 44 in the yoke 48 includes a generally circular outer portion 58 and a double-D shaped inner portion 62 that corresponds generally in size and shape to the shape of the end 40 of the shaft 20. The generally circular outer portion 58 of the aperture 44 includes a chamfer or lead-in 66 and is sized and configured to receive the larger diameter portion of the shaft 20. The double-D shaped inner portion 62 is sized and configured to receive the end 40 of the shaft 20.

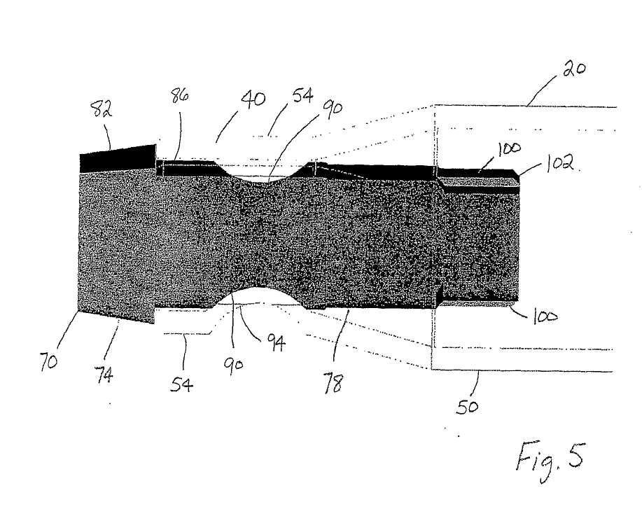

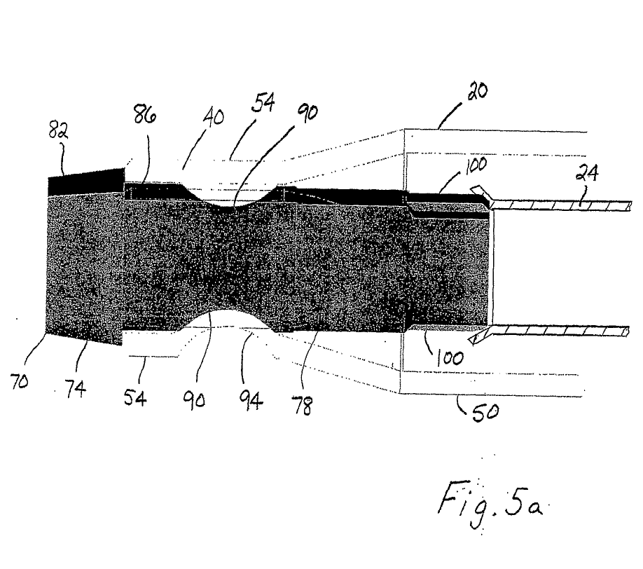

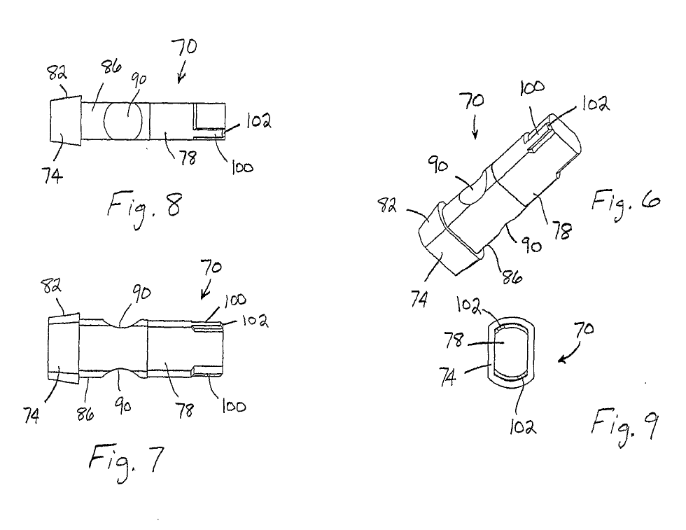

Inserting the end 40 of the shaft 20 into the aperture 44, and particularly into the inner portion 62 of the aperture 44, is facilitated by the presence of an insertion aid in the form of a plug 70 in the end 40 of the shaft 20. As best shown in FIGS. 4-9, the illustrated plug 70 includes a tapered end portion 74 and a body portion 78 coupled with the tapered end portion 74. In the illustrated embodiment, the portions 74 and 78 are integrally formed, however, in alternate embodiments, the portions 74 and 78 could be separate parts connected together.

The tapered end portion 74 defines a tapered outer surface 82, that in the illustrated embodiment, has a double-D shaped configuration corresponding generally to the double-D shaped configuration of the end 40 of the shaft 20 and the inner portion 62 of the aperture 44. The tapered outer surface 82 greatly facilitates insertion of the end 40 of the shaft 20 into the aperture 44, especially due to the difficult assembly conditions described above. The tapered outer surface 82 acts as a lead-in that helps to intuitively align (both axially and rotationally) the end 40 of the shaft 20 with the inner portion 62 of the aperture 44 for quicker and easier insertion. While the inner portion 62 could also include a chamfered lead-in portion, such a chamfer would be difficult to form on the inner portion 62 and is not needed due to the tapered outer surface 82 on the plug 70.

The body portion 78 of the plug 70 is received in the hollow end 40 of the shaft 20. At least part of the illustrated plug 70 has a generally double-D shaped outer surface 86 sized and configured to allow the plug to be press-fit into the end 40 of the shaft 20. In other embodiments, the plug 70 can have differing outer surface profiles provided the plug can be suitably secured in the end of the shaft.

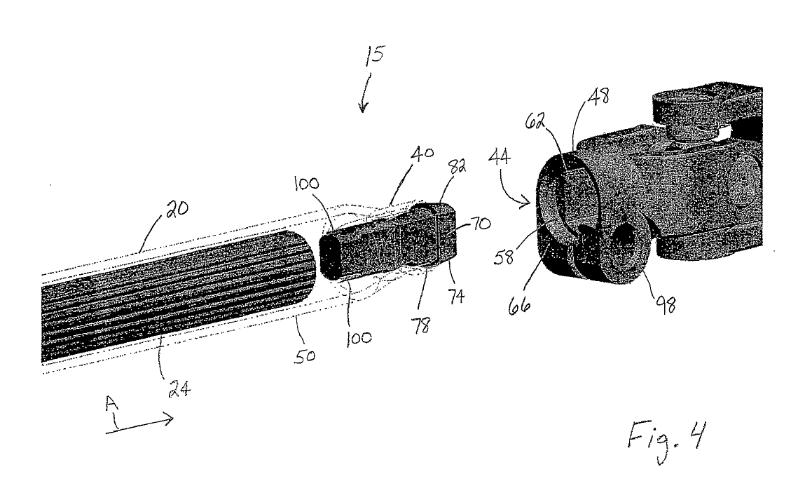

The illustrated body portion 78 also includes other features that facilitate assembly of the intermediate shaft assembly 15. As best shown in FIGS. 5-8, the body portion 78 includes oppositely facing transverse grooves or recesses 90 formed therein. These recesses 90 act as a mandrel or forming aid for forming a corresponding transverse groove or recess 94 in the end 40 of the shaft 20. Such a recess 94 is commonly referred to as a “whistle notch” and provides clearance for a fastener (not shown) that is inserted into an aperture 98 (see FIGS. 2-4) in the clamp yoke 48. The fastener passes through the clamp yoke 48 and is partially received in the whistle notch 94 to retain the shaft 20 in position in the yoke 48 until the fastener is tightened to clamp the clamp yoke 48 around the end 40 of the shaft 20, thereby securing the shaft 20 to the yoke 48.

In prior constructions not utilizing the plug 70, a separate forming mandrel had to be inserted into the end of the shaft to facilitate forming (e.g., coining) the whistle notch in the shaft. By providing the transverse recesses 90 directly in the body portion 78 of the plug 70, no such forming mandrel is required. Additionally, by providing two recesses 90 in the body portion 78, there is no right or wrong orientation for insertion of the plug 70 into the shaft 20. The whistle notch 94 can be formed into the appropriate curved wall portion of the shaft 20 irrespective of how the plug 70 is oriented in the shaft 20. Furthermore, forming the whistle notch 94 permanently secures the plug 70 into the end 40 of the shaft 20. Therefore, the original press-fit of the plug 70 into the shaft 20 can be a relatively loose press-fit due to the permanent securement provided by the subsequent formation of the whistle notch 94.

The plug 70 increases the strength of the connection between the shaft 20 and the yoke 48 in that the presence of the plug 70 inside the end 40 of the shaft increases the strength of the end 40 of the shaft 20. The increased strength helps resist deformation or collapse of the end 40 of the shaft 20 as the clamp yoke 48 is tightened around the end 40 of the shaft 20. Additionally, the presence of the illustrated plug 70 inside the end 40 of the shaft operates to substantially seal the shaft 20 such that fluid or gas present in the engine compartment cannot flow through the shaft 20 into the passenger compartment.

With continued reference to FIGS. 5-9, the illustrated plug 70 further includes a forming feature in the form of one or more ribs 100 at the end of the body portion 78 opposite the tapered end portion 74. The ribs 100 are raised from the adjacent surface profile of the body portion 78 and include tapered surfaces 102 at the distal end. Referring to FIG. 4, the splined inner tube 24 is received in the shaft 20 and is pressed into the shaft 20 in the direction of the arrow A in FIG. 4 until the body portion 78 of the plug 70 enters the hollow end of the inner tube 24. The ribs 100 are sized and configured to deform or flare the inner tube 24 as it is pressed onto the end of the plug 70 (see FIG. 5a). This deformation or flaring of the inner tube 24 provides an anti-pull-apart feature between the inner tube 24 and the shaft 20 and prevents the tube 24 and shaft 20 from becoming disassembled from one another. The illustrated ribs 100 represent only one possible configuration for the forming feature. Those skilled in the art will understand that other configurations of the forming feature (e.g., teeth, semi-spherical projections, and the like) can be used to achieve the same results.

The illustrated plug 70 can be made from pressed and sintered powdered metal, can be molded from a relatively high-strength plastic, can be machined from metals including, but not limited to steel and aluminum, or can be manufactured from other suitable materials. It should also be noted that the particular double-D shaped configuration for the shaft 20, the inner portion 62 of the aperture 44, and the plug 70 can vary depending on the application. In other embodiments, the shaft, the aperture in the yoke, and the plug may have only a single-D shaped configuration. Other applications may incorporate generally circular, elliptical, or polygonal shaped profiles. The insertion aid of the present invention can be modified for use in any such applications. Additionally, while the assembly aid of the present invention is described for use in steering column assemblies, such description is not intended to be limiting. The insertion aid of the invention can be used in other applications involving the insertion of a shaft into an aperture in an outer member. The invention also contemplates the use of an insertion aid that can be coupled to the end of a shaft that may not be completely hollow, such that the insertion aid is secured over the end of the shaft or directly to the end of the shaft.

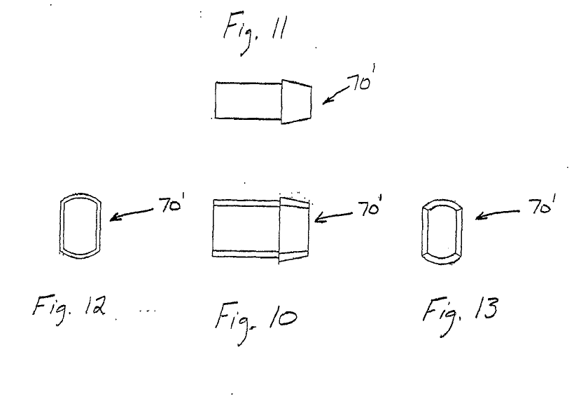

Additionally, the insertion aid need not include the whistle-notch forming feature or the anti-pull-apart forming feature described above. For example, FIGS. 10-13 illustrate another embodiment of a plug 70′ that does not include such features. Alternatively, a plug according to the invention may include only one of either the whistle-notch forming feature or the anti-pull-apart forming feature described above.

Various features of the invention are set forth in the following claims.

What is claimed is:

1. A shaft assembly comprising:
an outer member having an aperture;
a shaft having an end configured to be received in the aperture of the outer member; and
an insertion aid coupled with the end of the shaft to facilitate insertion of the shaft into the aperture in the outer member.

2. The shaft assembly of claim 1, wherein the insertion aid includes a tapered surface configured to facilitate insertion of the insertion aid into the aperture.

3. The shaft assembly of claim I, wherein the insertion aid is a plug coupled to the end of the shaft.

4. The shaft assembly of claim 3, wherein the shaft is a hollow shaft, and wherein the plug includes a body portion configured to be received in the end of the hollow shaft.

5. The shaft assembly of claim 4, wherein the body portion includes a transverse recess configured to aid in the formation of a transverse recess in the shaft.

6. The shaft assembly of claim 4, wherein the body portion includes a forming feature configured to deform a tube received within the hollow shaft and over the body portion of the plug.

7. The shaft assembly of claim 4, wherein the plug includes a tapered end portion coupled to the body portion, the tapered end portion extending from the end of the hollow shaft.

8. The shaft assembly of claim 4, wherein the presence of the body portion within the end of the hollow shaft increases an ability of the end of the hollow shaft to resist deformation when the outer member is secured to the end of the hollow shaft.

9. The shaft assembly of claim 4, wherein the plug substantially seals the end of the hollow shaft.

10. The shaft assembly of claim 3, wherein the plug is made from powdered metal.

11. The shaft assembly of claim 3, wherein the plug is made from plastic.

12. The shaft assembly of claim 3, wherein the plug is made from metal.

13. The shaft assembly of claim 3, wherein the end of the shaft and the plug each have a D shaped outer profile.

14. The shaft assembly of claim 3, wherein the end of the shaft and the plug each have a double-D shaped outer profile.

15. The shaft assembly of claim 1, wherein the shaft is an intermediate shaft of a steering column assembly.

16. The shaft assembly of claim 15, wherein the outer member is a yoke.

17. A shaft assembly comprising:
an outer member having an aperture;
a hollow shaft having an end configured to be received in the aperture of the outer member; and
a plug having a body portion configured to be received in the end of the hollow shaft, and wherein the body portion includes a transverse recess configured to aid in the formation of a transverse recess in the hollow shaft.

18. The shaft assembly of claim 17, wherein the plug includes a tapered end portion coupled to the body portion, the tapered end portion extending from the end of the hollow shaft to facilitate insertion of the hollow shaft into the aperture.

19. The shaft assembly of claim 17, wherein the plug is made from metal.

20. A shaft assembly comprising:
an outer member having an aperture;
a hollow shaft having an end configured to be received in the aperture of the outer member; and
a plug having a body portion configured to be received in the end of the hollow shaft, and wherein the body portion includes a forming feature configured to deform a tube received within the hollow shaft and over the body portion of the plug.

21. The shaft assembly of claim 20, wherein the forming feature is a rib.

22. The shaft assembly of claim 20, wherein the plug includes a tapered end portion coupled to the body portion, the tapered end portion extending from the end of the hollow shaft to facilitate insertion of the hollow shaft into the aperture.

23. The shaft assembly of claim 20, wherein the plug is made from metal.
